(19) United States
(12) Patent Application Publication
(10) Pub. No.: US 2012/0284157 A1
(43) Pub. Date: Nov. 8, 2012

(54) Continuing disclosure notification system

(75) Inventor: Gregg L. Bienstock, Larchmont, NY (US)

(73) Assignee: Lumesis, Inc., Stamford, CT (US)

(21) Appl. No.: 13/461,102

(22) Filed: May 1, 2012

Related U.S. Application Data
(60) Provisional application No. 61/481,576, filed on May 2, 2011.

(51) Int. Cl. G06Q 40/00

(52) U.S. Cl. 705/35

(57) ABSTRACT

A method and system for managing information related to fixed income securities and characteristics of investor-sought securities by users of a management and information system employing a computer system and a computer communication network. The method including the steps of entering into the computer system characteristics of a users fixed income security portfolio. CUSIP information for securities included, in the user entered fixed income security portfolio are identified. Disclosure material from EMMA using identified CUSIP information for securities included in the user entered fixed income security portfolio are retrieved and notification is provided to the user containing the retrieved disclosure material.

### CROSS REFERENCE TO RELATED APPLICATIONS

This application claims priority to U.S. application Ser. No. 61/481,576, filed May 2, 2011, which is hereby incorporated by reference in its entirety.

### FIELD OF THE INVENTION

The invention relates to a system that automatically notifies users of updates to information relevant to their fixed income portfolio(s) positions.

### BACKGROUND OF THE INVENTION

The Electronic Municipal Market Access system, or EMMA, is a comprehensive, centralized online source for free access to municipal disclosures, market transparency data and educational materials about the municipal securities market. EMMA houses municipal disclosure documents that provide information for investors about municipal securities. These include offering documents, called official statements, for most new offerings of municipal bonds, notes, 529 college savings plans and other municipal securities issued since 1990. EMMA also provides access to advance refunding documents, which detail arrangements made when new bonds are issued to establish escrows to pay-off existing bonds, and continuing disclosure documents that describe material information throughout the life of a bond and must be provided by municipal bond issuers. Additional disclosures that are voluntarily provided by issuers may be available for some bonds.

EMMA also provides market transparency data, which includes real-time prices and yields at which bonds and notes are bought and sold. Interest rates for municipal securities, including those for auction rate securities and variable rate demand obligations, are available on EMMA as well.

EMMA is a service of the MSRB, the self-regulatory organization that protects investors, issuers of municipal securities and entities whose credit stands behind municipal securities, and public pension plans by promoting a fair and efficient municipal market. The MSRB fulfills this mission by regulating securities firms, banks and municipal advisors that engage in municipal securities and advisory activities.

Investing in new issue and secondary bonds may be complicated for all investors.

### SUMMARY OF THE INVENTION

A general purpose of the present invention Continuing Disclosure Management Service (CDMS) is to manage updates of municipal portfolio positions to the Electronic Municipal Market Access (EMMA) system of the Municipal Securities Rule Making Board (MSRB) through a seamless process resulting in the user receiving an electronic notification (e.g., email) when a continuing disclosure notice or material event notice is filed by an issuer, obligor or other submitter of said notice with the MSRB. The noted prior art problems solved are the user's need to manage and maintain updates to the EMMA system for receipt of disclosure notices, their ability to select the types of disclosure notices to receive and for users to receive notifications that contain issuer, obligor and submitter identification, aggregation in one email of CUSIPs from the user's portfolio(s) where a notification applies to more than one CUSIP and portfolio identification. To the extent a user has loaded their portfolio(s) to research and/or asset management system (and for any subsequent updates) the present invention CDMS system will perform the updating task for the user, the user can select all portfolios loaded at a single time, the CDMS system will deliver to the user, within minutes of the continuing disclosure being filed with the MSRB, a detailed email with the issuer, obligor, submitter, CUSIP(s) and portfolio(s) subject to the disclosure notice along with a link to the disclosure document(s).

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 illustrates a computing system configured and operative for use with the present invention;

FIGS. 2 and 4 illustrate flow diagrams in accordance with a below description of the invention;

FIGS. 3 and 5 illustrate screen shots of a website interface depicting an illustrated embodiment of the present invention; and

FIG. 6 illustrates an exemplary electronic notification provided by an embodiment of the invention.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

This invention is to be understand in conjunction with U.S. patent application Ser. No. 13/046,405 entitled Method And Data Processing System For Financial Planning, the contents of which are hereby incorporated by reference in their entity. The method and system illustrated and described herein are applicable to security assets, fixed income securities and the like.

It is to be understood the present invention may be included within a client-server based electronic information management system operating over a computer network on separate hardware. For instance, the invention may be implemented as an information management and database interface software application is integrated with other software applications utilized by a variety of different users and locations that, in combination, make up the information management and database interface system implemented on a computer system. Each part of the electronic information management system serves to facilitate the communications between issuers, investors, and other market participants in the primary bond market.

By way of illustration, institutional buy side users (including individual retail investors) as well as institutional securities investors such as trust departments, fund managers, and investment managers of institutional and individual clients' accounts, who are responsible for identifying and researching new issue bonds and managing portoflios. Sell-side users are issuers as well as their agents including broker/dealers and underwriters. Both buy-side and sell-side market participants use the electronic continuing disclosure management system as described herein.

The invention provides for the electronic integration and distribution of continuing disclosure filings made with the MSRB in a detailed, unique way. Issuers and/or broker/dealers can deliver to the MSRB continuing disclosure documents and information. The system, after retrieving all disclosures from the MSRB, distributes the continuing disclosure notifications and information to investors and other market participants using the system. The information is formatted as an email that identifies for the user in the email subject line the type of continuing disclosure filing (thereby allowing the user to create rules to receive only those continuing disclosure notices they opt to receive)and, in the body of the email identifies the issuer, obligor, submitter, type of disclosure(s), CUSIP(s), portfolio(s) and links to the specific disclosure document(s). After opening the email, the user can review the information and conduct due diligence to evaluate the impact of the continuing disclosure for any of the bonds in its portfolio(s) or those of its clients.

The Continuing Disclosure Management Service (CDMS) system) can include various computer subsystems. The system's software application can be executed on computer subsystems that include a web server (or web servers) addressable at a web site on the Internet or other computer communication networks. Investors send data to and receive data from the web-based management software application over an Internet connection from a computer subsystem that is executing a compatible software application. Investors' computer subsystem can include a personal computer or other similar computer devices (e.g., a smartphone, tablet and the like). Investors can access the web-based software application and database hosted on a web server by an application service provider through conventional web access controls and techniques.

Similarly, each issuer or issuer agent can send data to the MSRB and the system receives all disclosures filed with the MSRB over an Internet connection from a computer subsystem, such as a personal computer, through a conventional web browser and deliver the same in a unique format, as described herein, to enrolled users of CDMA. For all computer subsystems, hardware such as personal phones, computer tablets, or other portable and wireless devices are also contemplated.

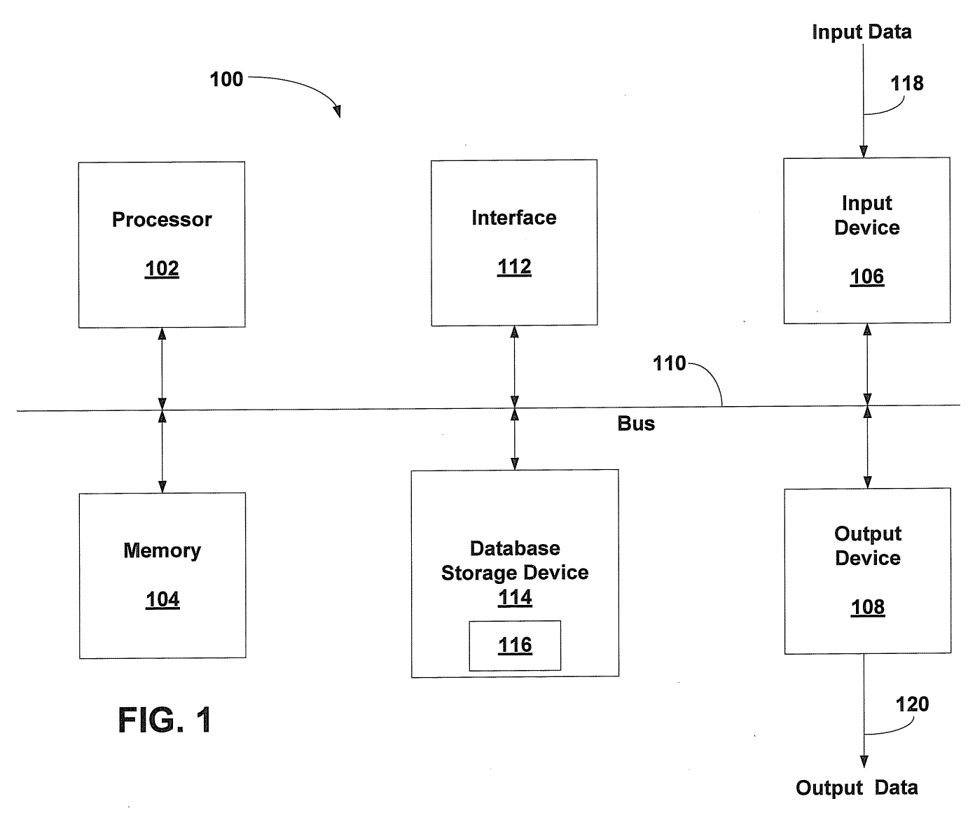

Turning now descriptively to the drawings, in which similar reference characters denote similar elements throughout the several views, FIG. 1 depicts an exemplary computer system and subsystem contemplated by the invention.

FIG. 1 illustrates a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc.

Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

With the exemplary computing system environment 100 of FIG. 1 being generally shown and discussed above, a method of operation of the present invention utilizing system 100 will now be described.

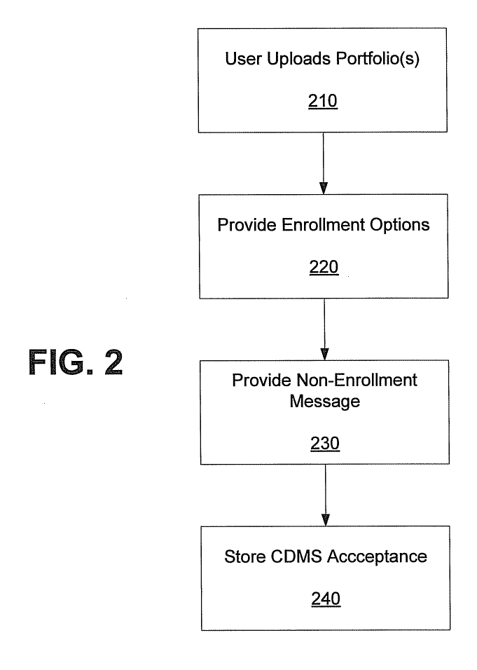

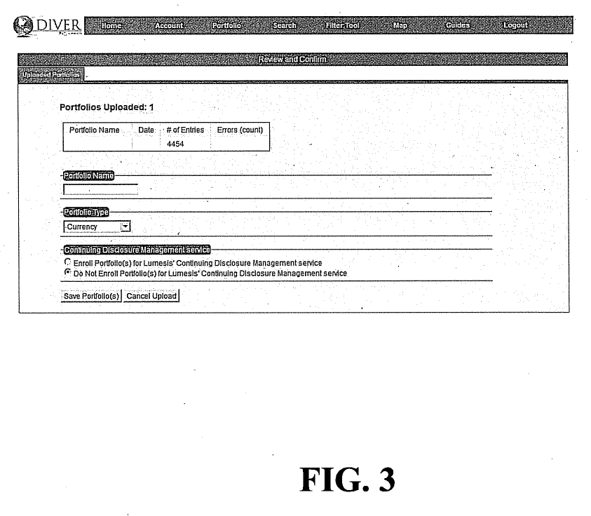

With reference now to FIGS. 2 and 3, the process for a user to obtain the Continuing Disclosure Management Service (CDMS), as provided by system 100, or components thereof, will now be described. It is to be understood, CDMS preferably works in conjunction with an asset management system, such as that disclosed in U.S. patent application Ser. No. 13/046,405.

Starting at step 210, a user, when loading its fixed income asset portfolio(s), will have the option to enroll for the Continuing Disclosure Management Service (CDMS) for each uploaded portfolio. Once the User successfully uploads its initial portfolio (e.g., the “Review and Confirm” Screen (FIG. 3)), the following user options are preferably presented to be elected by a user (step 220):
1. Enroll Portfolio(s) for CDMS
2. Do Not Enroll Portfolio(s) for CDMS

In the event a user does not select enrollment in the CDMS and the user attempts to upload the portfolio, a system 100 preferably provides a message advising them they are uploading a portfolio but have not enrolled in the CDMS (step 230). If a user does enroll in the CDMS, system 100 preferably provides a message advising the user that they (i) elected the CDMS Service, (ii) the user will receive an electronic confirmation (e.g., email) of the same within a predetermined period of time and (iii) the user “Agrees” to stated terms and conditions. If a user does not click “Agree” or “Decline” and seeks to move forward, the system 100 preferably provides a message advising the user they failed to select an action and need to do so to continue to upload their portfolio. If the user proceeds with selecting “I do not accept the terms” or “Decline”, the user is not enrolled in the CDMS but the portfolio is uploaded to the research and/or asset management system. If the user elects “Accept”, the system 100 preferably stores their acceptance in memory, preferably in association with a user account (step 240). Once the user completes the election process, the user preferably completes the name and portfolio type as they normally would for a portfolio. It is to be appreciated that if the user enrolls and accepts CDMS, for future uploads, the user preferably does not need to enroll again. In accordance with the illustrated embodiment, it is also to be appreciated that if the user elected not to enroll for the CDMS, for subsequent portfolio uploads, the CDMS enrollment process for such subsequent portfolio uploads are preferably repeated. It is further to be appreciated that if the user uploads multiple portfolios at a single time and elects to enroll, the enroll election is applicable to all portfolios loaded at that time.

It is to be additionally appreciated that if the user enrolls and accepts CDMS, an electronic notification (e.g., email) is preferably sent to the user advising that the portfolio(s) uploaded to system 100 will be enrolled in the CDMS service. Thus, upon upload of any new user portfolio, the system 100 preferably generates an electronic notification to the user that User Portfolio(s), uploaded to system 100 have been enrolled in the CDMS Service.

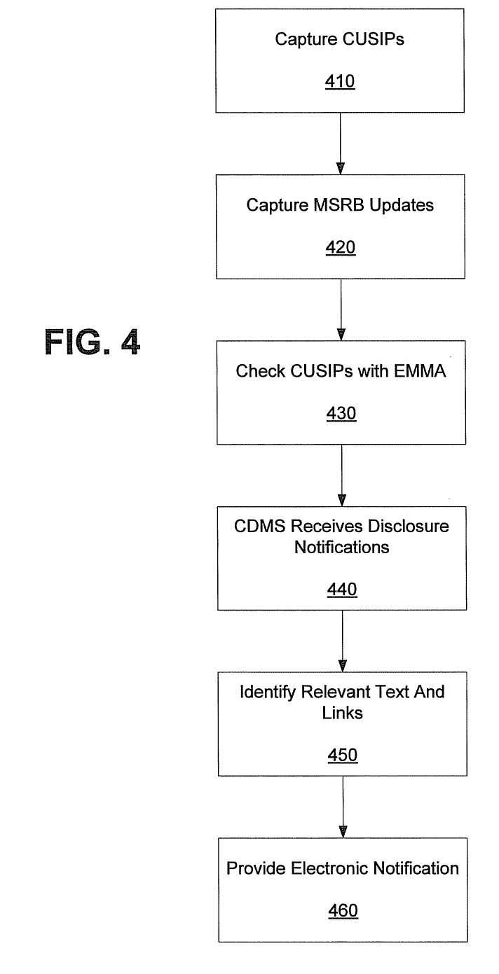

With reference now to FIG. 4, CDMS System Operations will now be described. Upon user upload, the system 100 is configured and operative to capture the CUSIPs for the securities in the user uploaded portfolio and preferably the associated email address of the user that uploaded the portfolio in a table that the system 100 will use to automatically deliver electronic notifications to users (step 410). It is to be appreciated system 100 is adapted and configured to capture multiple email addresses from different users for the same CUSIP and is further operative to receive additions of CUSIPs, email addresses and the deletion of the same from a daily or more frequent feed based upon changes made by users. It is also to be understood that upon portfolio(s) being uploaded and CDMS being opted for by a user, the portfolio entries and user account are updated in CDMS system 100. As part of this process, the CDMS system 100 preferably performs an automated check to ensure all enrolled CUSIPs match those in EMMA (step 430).

CDMS system 100 thereafter receives periodic updates (e.g., every five minutes), preferably via a subscription to the Municipal Securities Rulemaking Board's (MSRB) Continuing Disclosure Service (Subscription), preferably via a dedicated account registered with the MSRB for the Subscription (step 420). It is to be understood that preferably on a periodic basis—approximately every five minutes—throughout a day, CDMS system 100 retrieves disclosure notifications filed by issuers, obligors and other filers with the MSRB for the period covering from the last retrieval until the time of the most recent CDMS system 100 retrieval. Upon the CDMS system's 100 receipt of a continuing disclosure notification from EMMA (step 440), the CDMS system 100 is configured and operative to identify relevant text and links (step 450) and insert the same in an electronic notification (e.g., email) to be delivered to all users registered for the CDMS service holding that CUSIP (step 460).

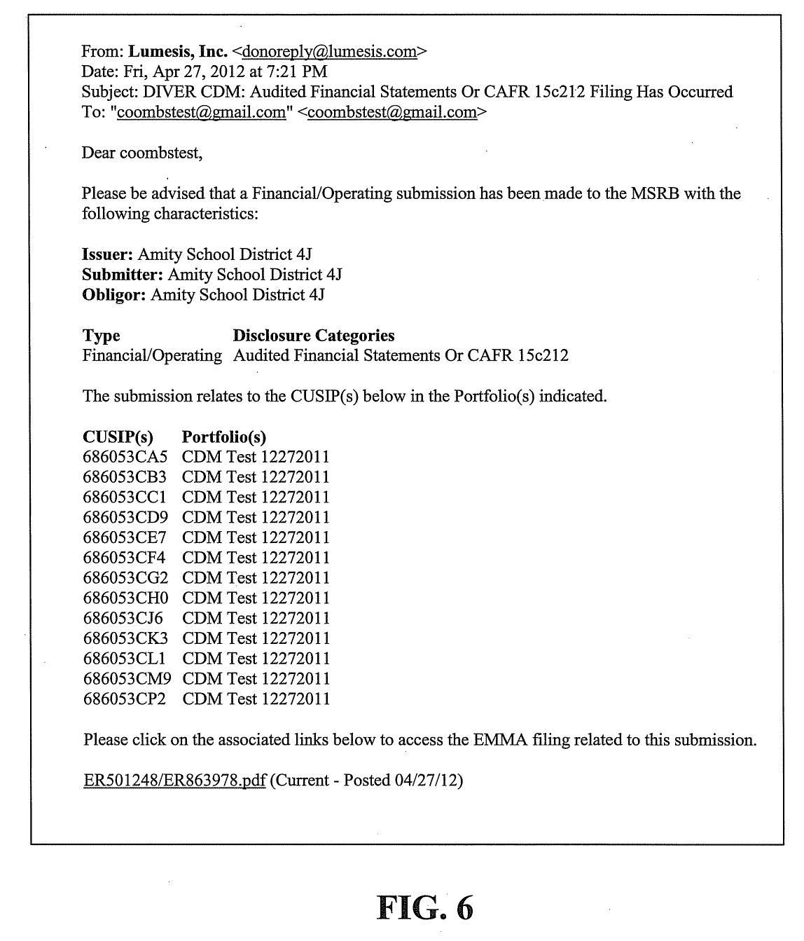

With reference to FIG. 6, depicted is an exemplary electronic notification generated by system 100 wherein the electronic notification is shown generated as an email notification which identifies for the user the type of disclosure in the subject line of the email. This allows for the user to select which types of disclosures to receive in their email box or to be immediately sent to a distinct email folks or deleted file. With further reference to FIG. 6, the email notification identifies, so long as the same is identified in the filing with the MSRB, the issuer and/or obligor; the submitter is always identified. The email identifies the CUSIP(s) and portfolio(s) that the continuing disclosure has application to and provides a direct link to the continuing disclosure document(s) stored on the CDMS system.

It is to be appreciated that preferably the aforesaid electronic notification sent to registered CDMS subscribing users is generated in a relative short amount of time (e.g., within 5 minutes) of the CDMS system's 100 retrieval of the notice from the MSRB Subscription. It is to be further understood that the CDMS system 100 is further configured and operative to take counts of notices received, users enrolled for notice by CUSIP and electronic notifications sent. The CDMS system 100 is further configured and operative such that failed delivery receipt is automatically forwarded to dedicated system 100 email address.

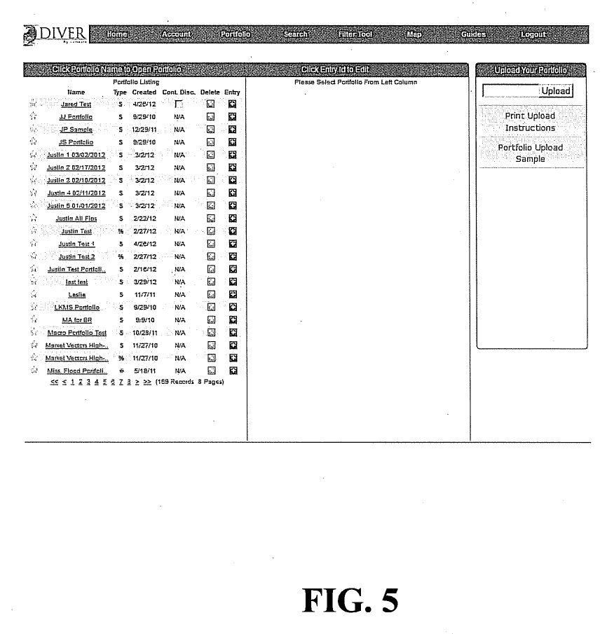

With reference now to FIG. 5, and in accordance with an illustrated embodiment of CDMS system 100, under “Portfolios” and “List Portfolios”, for each portfolio the CDMS system 100 preferably provides a “Cont. Disc.” column with an active/inactive notation to denote if the CDMS service is active for each user portfolio. Preferably in the same aforesaid table, the CDMS system 100 is configured and operative to provide the user the ability to change their election from active to inactive or inactive to active.

The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention, and of the manner and process of making and using them, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention wireless landing gear system encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A method of managing information related to fixed income securities and characteristics of investor-sought securities by users of a management and information system employing a computer system and a computer communication network, comprising:
entering into the computer system characteristics of a users fixed income security portfolio;
identify CUSIP information for securities included in the user entered fixed income security portfolio;
retrieve disclosure material from EMMA using identified CUSIP information for securities included in the user entered fixed income security portfolio; and
provide the retrieved disclosure material in an electronic notification to the user.

2. A method as recited in claim 1 wherein the retrieved disclosure material includes text and links identified in EMMA that are relevant to the user entered fixed income security portfolio.

3. A method as recited in claim 1 wherein a user enters into the computer system a plurality of fixed income security portfolios.

4. A method as recited in claim 3 wherein the user selectively chooses which entered fixed income security portfolios are to cause the computer to retrieve disclosure material from EMMA.

5. A method as recited in claim 1 wherein the electronic notification is an email message.

6. A method as recited in claim 1 wherein the retrieve disclosure material step includes parsing data and information retrieved from the MSRB's EMMA system and identifying text and continuing disclosures applicable to a user portfolio.

7. An apparatus to managing information related to fixed income securities and characteristics of investor-sought securities by users of a management and information system, comprising:
a memory;
a processor disposed in communication with said memory, and configured to issue a plurality of instructions stored in the memory, wherein the instructions issue signals to:
enter into the computer system characteristics of a users fixed income security portfolio;
identify CUSIP information for securities included in the user entered fixed income security portfolio;
retrieve disclosure material from EMMA using identified CUSIP information for securities included in the user entered fixed income security portfolio and parse data and information retrieved from the MSRB's EMMA system and identifying text and continuing disclosures applicable to a user portfolio; and
provide the retrieved disclosure material in an electronic notification to the user.
